(19) United States
(12) Patent Application Publication
(10) Pub. No.: US 2006/0137414 A1
(43) Pub. Date: Jun. 29, 2006

(54) Vending-machine lock with motor-controlled slide-bar and hook mechanism

(75) Inventors: William D. Denison, Lake Zurich, IL (US); Gary L. Myers, Monee, IL (US); Richard Paeth, St. Charles, IL (US); Catalin Captarencu, Wheeling, IL (US); Calin V. Roatis, Long Grove, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security LLC, Elk Grove, IL (US)

(21) Appl. No.: 11/248,314

(22) Filed: Oct. 12, 2005

Related U.S. Application Data
(60) Provisional application No. 60/618,069, filed on Oct. 12, 2004.

(51) Int. Cl. E05B 65/12; B60R 25/04

(52) U.S. Cl. 70/257

(57) ABSTRACT

The present invention provides a reversible motor to drive a slide and hook locking mechanism. The motor can drive the slide via a worm gear, in which case the worm drive is coupled to the slide through a crankshaft-type connection. Alternatively, the slide is gear-driven or connected using a push-pull cable or rod. An electronic control with a microcomputer interface controls the motor and may be operated by a keypad or by a remote wireless device.

### CROSS REFERENCE TO RELATED APPLICATION

This application claims priority to U.S. Provisional Patent Application 60/618,069, filed on Oct. 12, 2004, which is incorporated herein by reference in its entirety.

### TECHNICAL FIELD

The present invention relates generally to vending-machine locks and, more particularly, to such locks with slide-bar and hook mechanisms.

### BACKGROUND OF THE INVENTION

Snack food and glass-front vending machines today are typically secured with slide-bar and hook mechanisms in their doors. These hooks generally extend into a cabinet frame of the vending machine to secure the door. Locking the door is typically controlled by a rotatable exterior handle and by a mechanical T-handle mechanism. The handle is prevented from rotating by a mechanical core lock. In one example, a slide-bar configuration consists of one or more bars that are in a retracted position while the door is open and while the door is being closed. Once the door is closed, the operator takes the handle and rotates it through 90 or 180 degrees (depending on the geometry of the hooks), and the hooks extend into catches in the cabinet. To unlock, first an access-control device is accessed, then the slide-bar and hooks are retracted from the catches, and finally the handle is pulled to open the door. These methods are typically cumbersome and time consuming. In addition, such a vending machine typically has an unattractive handle and a dial or keypad lock mounted to the exterior of the door.

### SUMMARY OF THE INVENTION

In view of the foregoing, the present invention improves on the methods, operations, and interfaces of locking and unlocking a vending machine. The present invention makes it possible to remove certain components from the outside of a vending machine door. This improvement enhances security by providing a more difficult point of attack. It also provides additional exterior surface area on which to add decorative features to the vending machine door.

This invention is not limited to any particular type, style, or application of vending machine. In addition, although the preferred embodiment of the invention includes a door with a slide-bar and hook mechanism interfacing to catches in the cabinet of the vending machine, this invention also supports the opposite arrangement of a slide-bar and hook mechanism in a cabinet that interface to catches in the doorframe, as well as many other types of door, cabinet, and mechanism arrangements as are available. This invention also supports the arrangement of a motor controlling a slide bar consisting of catches which latch and un-latch into one or more hooks. A cable or rod can be used to interface the lock mechanism to the slide bar. When a rod is used, it can be modified to act as the latch itself.

The first object of the invention is to improve the locking and unlocking operation of a door by removing the need for a handle interfaced to a slide-bar and hook mechanism.

The second object is to replace manual movement of the slide bar with motor control movement of the slide bar.

The third object is to provide a less user-interactive procedure and an easier interface to access and lock the vending machine.

The fourth object is to provide a faster method for accessing and locking the vending machine.

The fifth object is to improve the security of the door and to remove the point of attack by removing an access-control unit from the door and replacing it with an electronic remote or removable keypad transmission device.

The sixth object is to provide a more user-friendly electronically controlled device to access and lock the door.

The seventh object is to provide a device that is battery powered, although the invention is not limited to battery-controlled operation.

### BRIEF DESCRIPTION OF THE DRAWINGS

While the appended claims set forth features of the present invention, the invention, together with its objects and advantages, may be best understood from the following detailed description taken in conjunction with the accompanying drawings of which:

FIG. 1 is an elevational view of one embodiment of a motor-controlled slide-bar mechanism together with a broken-out view taken along the line C-C and an enlarged view of the area D;

FIG. 2 is a front-plan view of the motor-controlled slide-bar locking system of FIG. 1;

FIG. 3 is an exploded view of the motor and drive for the controlled slide-bar locking system;

FIG. 3a is a perspective view of an alternate configuration of the mechanism showing how a helical gear can act as a direct interface for the slide assembly;

FIG. 3b is a perspective view of an alternate configuration of the mechanism showing a contained drive system;

FIG. 4 is a perspective view showing a rod or wire interconnection;

FIG. 5 is a perspective view showing yet another alternate construction and interconnection system;

FIG. 6 is a flowchart of a locked-to-unlocked transition;

FIG. 7 is a flowchart of an unlocked-to-locked transition;

FIG. 8 is a flowchart of a locked-to-unlocked transition with an optional receiver sensor; and

FIG. 9 is a flowchart of an unlocked-to-locked transition with an optional receiver sensor.

### DETAILED DESCRIPTION OF THE INVENTION

The following description is based on illustrative embodiments of the invention and should not be taken as limiting the invention with regard to alternative embodiments that are not explicitly described herein.

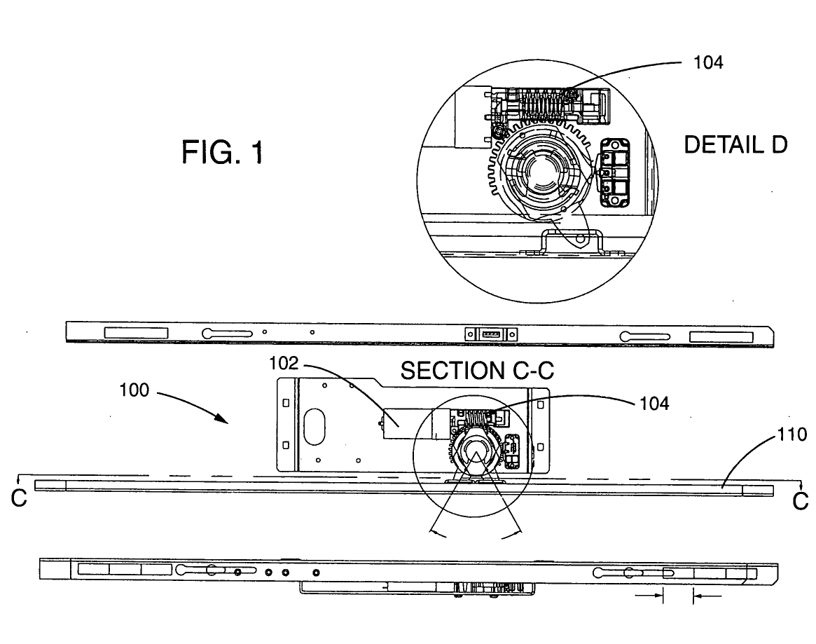

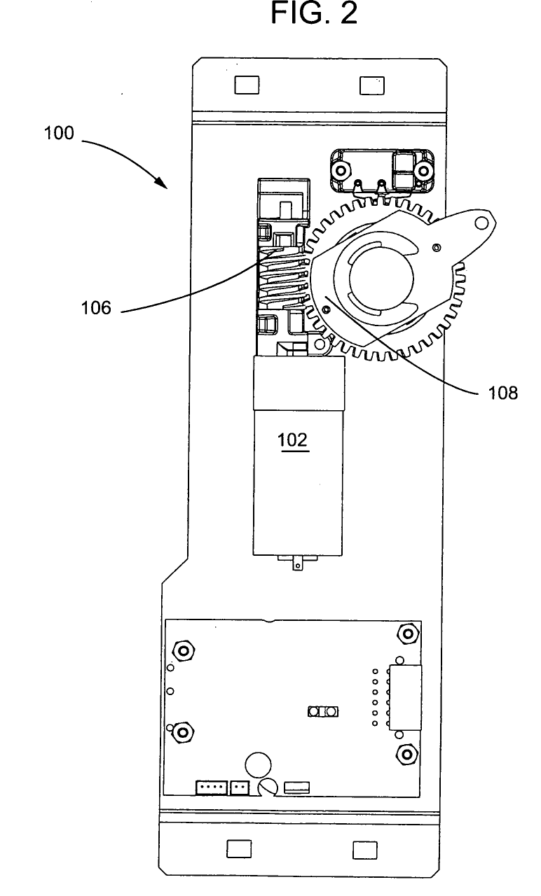

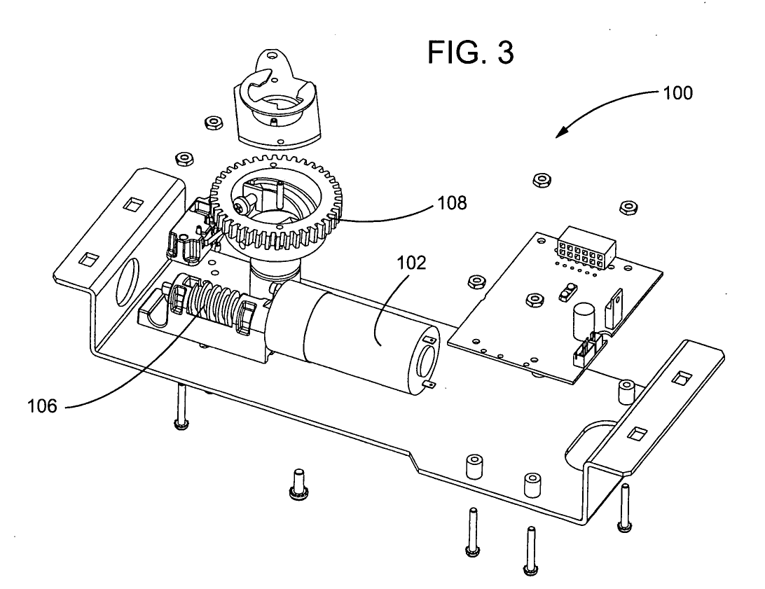

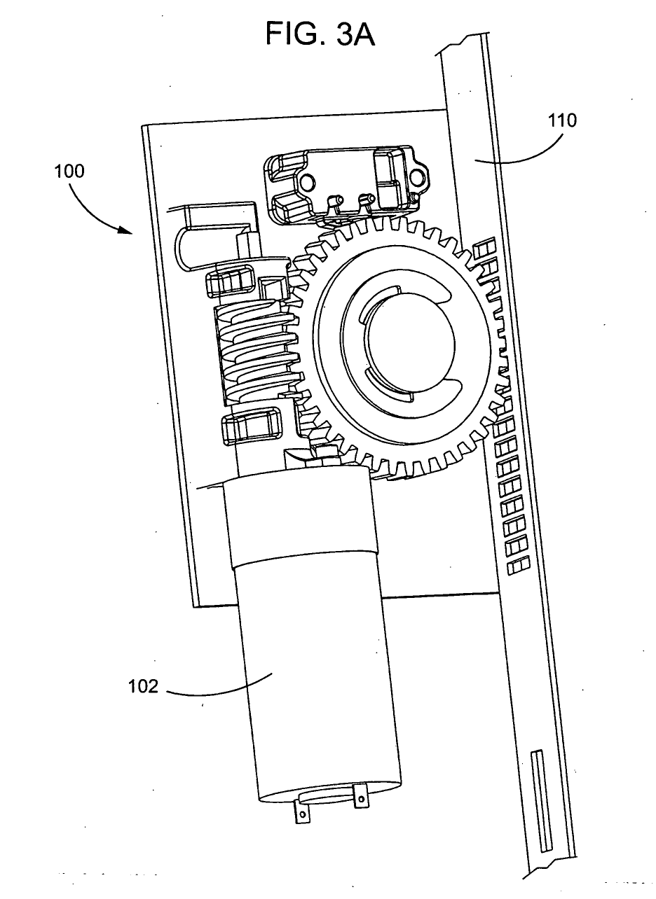

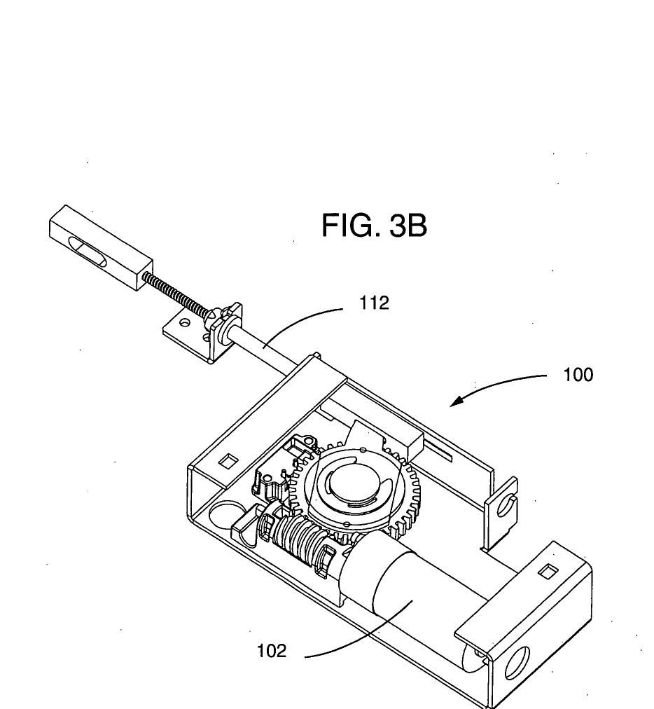

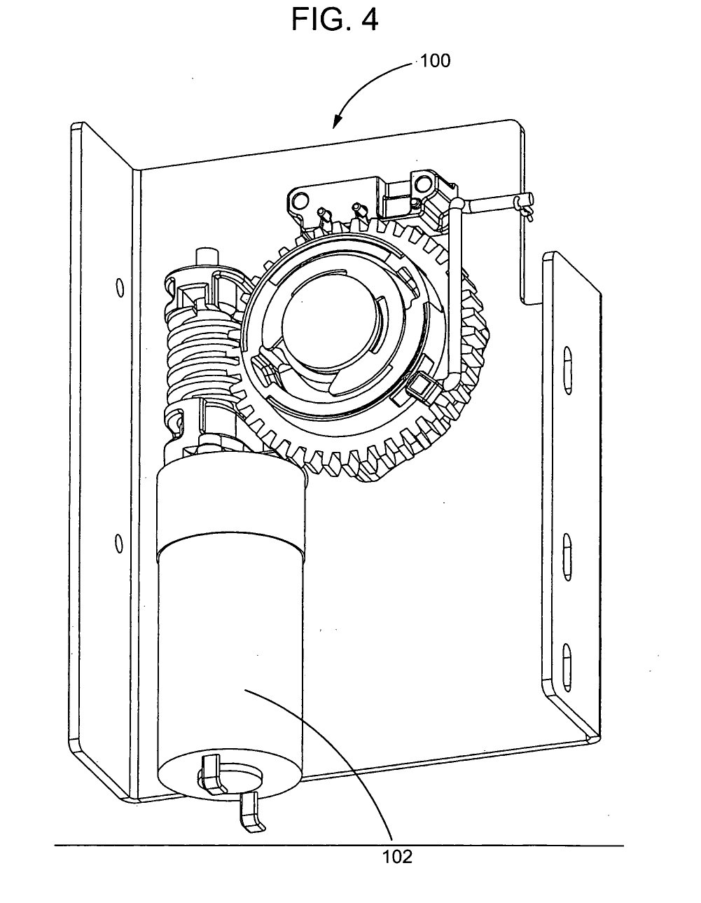

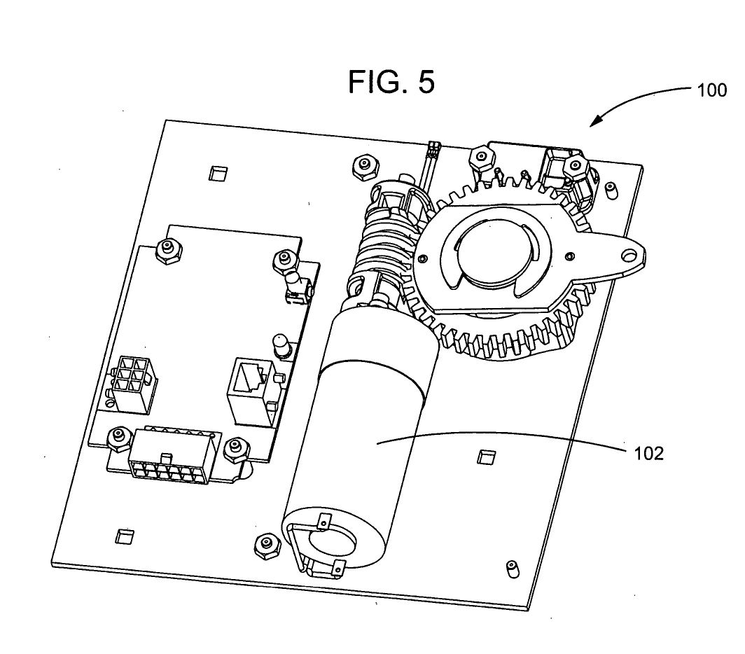

Embodiments of the present invention consist primarily of a motor-controlled mechanism to control the movement of a slide-bar in a vending machine or the like, an electronic-control interface to the motor mechanism, an access-control device, and a power source. Turning to the drawings, the motor-controlled locking mechanism 100 is shown in FIGS. 1, 2, 3, 3a, 3b, 4, and 5. This locking mechanism 100 replaces the handle-drive system typical in existing vending machines. The motorized lock 100 includes a motor 102 and a gear reducer 104. Together, the motor 102 and gear reducer 104 provide enough power to control and to move the locking mechanism, while they are also able to withstand a vandal's several hundred pounds of pry pressure. The rotational motion produced by the motor 102 is first reduced through smaller metal gears in a motor-mounted gearbox and then further reduced by an arrangement of a worm gear 106 to a helical gear 108 (see FIGS. 2 and 3). The helical gear 108 connects to at least two teeth of the worm gear 106 to withstand a considerable force when an external device tries to push in the mechanism and slide-bar 110 (see FIG. 3a). The connections between the helical gear 108 and the slide bar 110 shown in FIGS. 1, 3a, and 3b are representative of a variety of connection types available. All known other crankshaft-type mechanisms can be used in this type of drive.

The motor 102 can also connect to a cable-or rod-drive system 112 as shown in FIG. 3b. This type of drive allows the mechanism to be placed in a vending machine in a variety of positions where space or direct access to the slide bar 110 is not readily available. The rod 112 as shown can be replaced by a conventional push-pull cable. The rod or cable assembly 112 is housed so as to allow the lock mechanism 100 to be packaged as a single assembly.

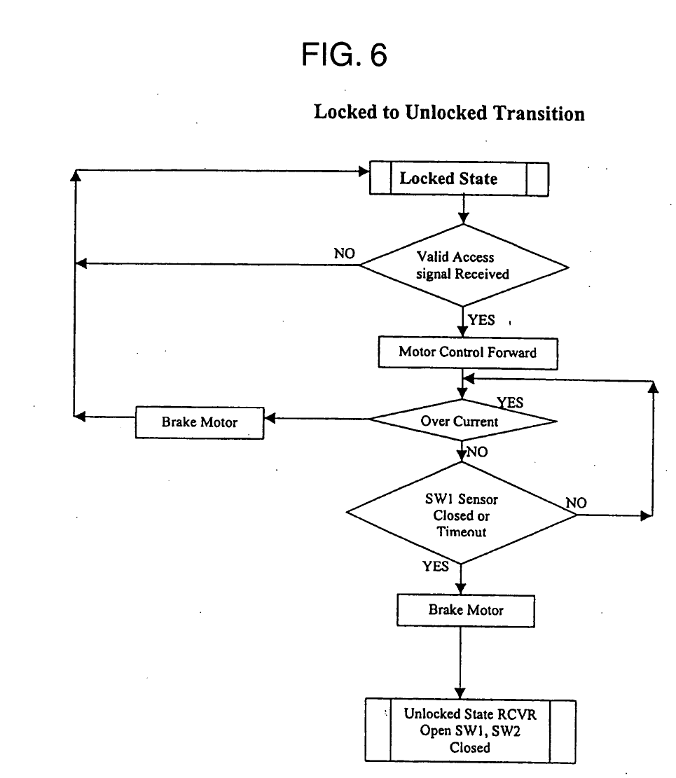

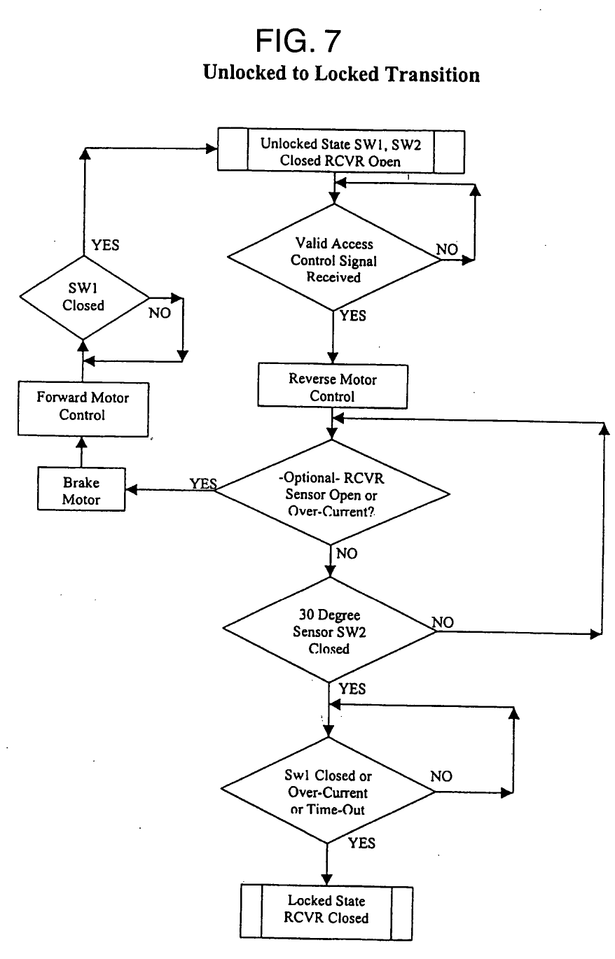

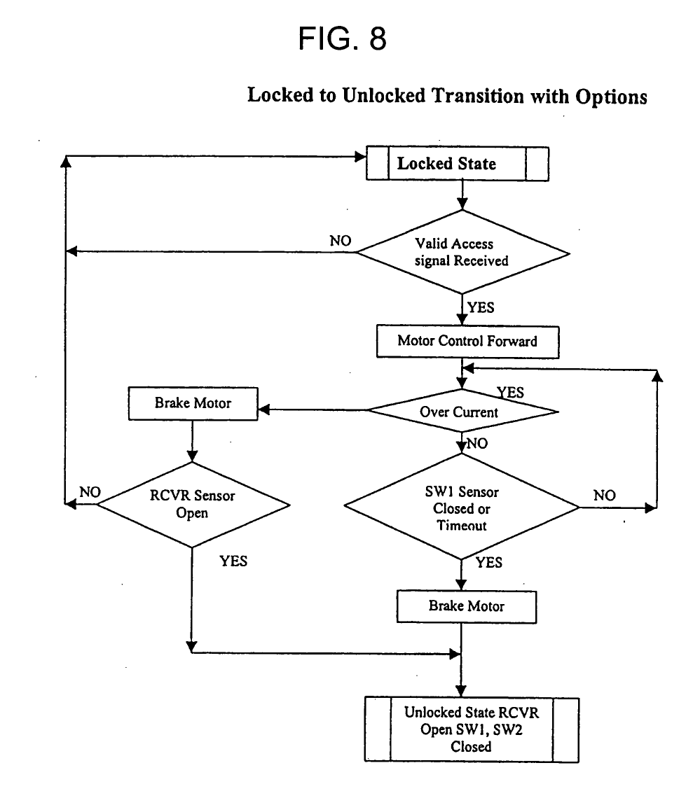

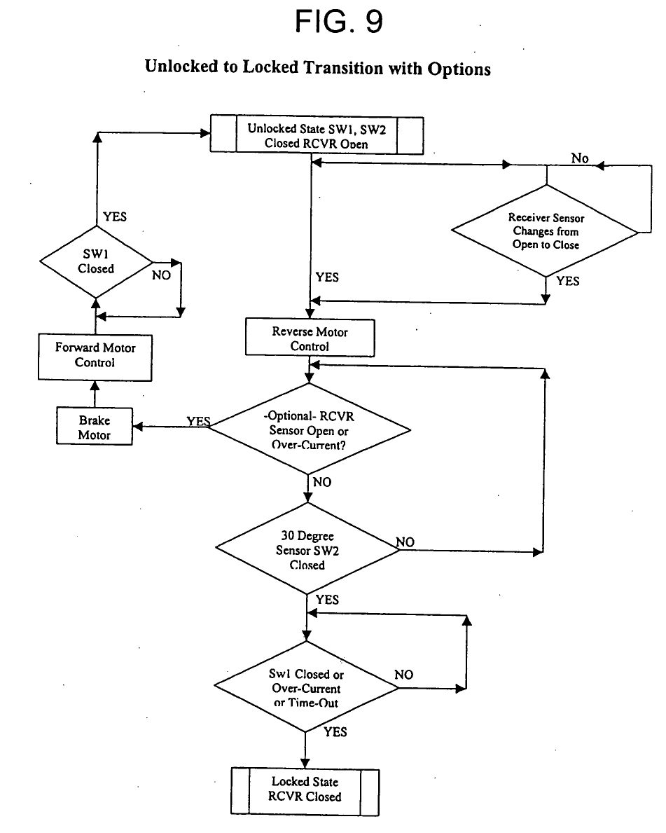

In accordance with some embodiments of the present invention, an electronic control connects to the motor 102 and to position switches of the motor mechanism. A microcomputer controls the mechanism by either driving the motor 102 in two directions (forward and reverse) or in a single direction to move the slide-bars I 10 in and out of the locked position (retracted and extended). The flow-charts of FIGS. 6 and 7 show a mechanism control using forward/reverse motor control and position sensors. Both the locking and unlocking modes of operations are triggered by a signal from an access-control device. The controller operates the motor 102 in conjunction with sensor switches, motor-current monitoring, and timers as described. The flow-charts of FIGS. 8 and 9 describe locking and unlocking procedures when a door-closed or receiver-switch sensor is used to detect the door in the closed position and then to automatically trigger the locking sequence.

As a general safety feature, the motor-control unit ceases to drive the motor 102 if it detects a slide-bar 110 impediment, a door jam, or a shorted-motor condition (where the motor current crosses a certain limit to indicate that a slide bar 110 is not moving). If this occurs at the beginning of the lock cycle (within approximately the first 30 degrees of gear rotation), then if the motor-control unit senses that a slide bar 110 is jammed, the motor 102 is reversed to return the mechanism to the fully retracted position. After 30 degrees of gear movement, if the motor current is exceeded, then the motor controller simply de-energizes the motor 102 without attempting to reverse it, thus leaving the vending machine door in the locked position. If an unlock signal is later received, then the motor controller proceeds to retract the slide bar 110 and to unlock the vending machine.

If a position switch is faulty, then the motor controller's fault-tolerant control logic allows the door to unlock if a correct access code is received.

As shown in FIG. 7, in a preferred embodiment the locking event for the vending machine door is controlled by an access signal from an access-control unit. In the alternative embodiment shown in FIG. 9, locking is triggered by a switch which measures the position of the door. This produces a lock-trigger signal when the door moves from the open to the closed position. In all cases, the access-control unit (when it receives a valid access code via a keypad or a remote unit) provides the trigger to unlock the slide bar 110. Examples of both keypad-and remote-controlled access-control units are described in U.S. Pat. Nos. 5,617,082 and 6,359,547, and in U.S. Published Patent Application US2003/0234719A1, which are incorporated herein by reference in their entireties.

Where a keypad lock mounted to a vending machine is used to access the motor control as described in the patents listed above, the keypad lock offers a simple user interface of keys (such as twelve access buttons) and LED lights or an LCD display to help the user enter access control commands, enter additional access codes, check the health of the battery, etc. The selection buttons of the vending machine can also be used for access-control input.

When an access-control unit is desired that has no point of attack, a wireless remote control device may be used. Such a wireless access device is described in U.S. Pat. No. 5,617,082. This device offers a battery-saver feature to reduce power consumption of the lock as it waits to receive an access-code transmission. Two examples of wireless media used for this device are radio frequency and infrared. The battery-saver feature can be implemented in a number of ways: (a) full-time wherein batteries are used to power the lock; (b) not at all wherein the power to the lock is a DC power source; (c) a combination of these two modes, wherein the power-saver mode is used when it is not expected that the lock will be immediately accessed or re-locked, and wherein the full-power mode is used when it is expected that the lock may be immediately accessed or re-locked. A less desirable aspect of the battery-saver feature is a time-delayed reaction to a lock or unlock access input. The dual mode takes advantage of the power-saver during long time periods when the lock most likely is not being locked or unlocked and takes advantage of the full-power mode to react quickly to a lock or unlock access-control signal.

Wireless access-control devices may take many forms, such as a remote transmitter with a single access-code transmit button. When this single transmitter button is pressed, the complete access code is transmitted to the access-control receiver, as described in U.S. Published Patent Application US2003/0234719A1. Alternately, the wireless device reads biometric input such as a fingerprint to replace a single button as the user interface.

The remote unit can also include several keypad buttons (labeled, for example, “0” through “9”) to allow a user to enter input combinations to make up an access code. As each button is pressed, an individual, unique code representing that button is transmitted to the access-control unit. The order and combination of the codes received from the remote make up the access code for the vending machine. An example of such a device is the universal remote-control unit for a television or other consumer device.

In the example given above of a universal remote-control unit, problems exist with annunciation and with user-friendly operation of the lock. For example, the universal remote typically contains only an LED light indicating that a button was pressed and that a code was transmitted, but there is no confirmation that a particular code was received by the access-control unit. Embodiments of the present invention offer two solutions to these problems.

As a first solution, the access-control unit contains an annunciation device such as LED lights, an LCD display, or an audio annunciator to provide feedback for the user as to exactly how many key presses are received by the remote transmitter. Note that these annunciations do not give any positive or negative feedback as to whether the code received was valid or invalid, only that it was received. It also attempts to annunciate the order in which each code is received. For example, if the expected code contains five digits, then the annunciator may attempt to either light or un-light one LED for each code received, providing both feedback that the code was received and what receiving sequence this code was in as it was received. Typically, this annunciator is located such that it can be viewed from just in front of the door (say, up to ten feet back from the door). Other messages may also be displayed such as a confirmation that the complete correct code was received, that an incorrect complete code was received, that the battery is low, that an incorrect button was pressed, or that the mechanism should be unlocking.

As a second solution, the access-control unit can contain a transmission system (typically using the same transmission medium as used by the remote unit), and the remote transmission unit can contain a wireless receiver system to receive the annunciation messages from the access-control unit. The same annunciation components can be used at the remote unit. Thus, the user transmits a code via the control unit; if received, the access-control transmits a confirmation back to the remote unit; and the remote unit displays an annunciation message to the user that the code was received. Other messages may be displayed just like the ones mentioned above.

The lock system can be power either by a battery source or by an AC or DC power source. If batteries are used, then it is assumed that they are mounted inside the vending machine and are not accessible while the door is locked. The batteries are monitored for their health, and a measure of that health is announced to the user as the vending machine is accessed or locked. The batteries are usually non-rechargeable alkalines, although rechargeable types are possible.

In the event that the batteries are too low to operate the unit, the preferred embodiment has a power input port that accepts a back-up power source to power the lock thus allowing the lock mechanism to unlock once a correct access code is received. This port does not provide a hotwire to over-ride the access-control system of the lock. One such battery-back-up unit is described in U.S. Provisional Patent Application 60/523,505. In some cases, a simple nine-volt battery can be used.

The lock also provides an over-ride system in case the electronics (the access-control unit or the motor-control unit) fail. The over-ride provides access to the motor wires if the vending machine is drilled in a certain location. Once gaining access to these wires, the motor is energized independently of the access-control and motor-control circuits, and the slide-bar is retracted to open the door. The faulty lock components are then replaced without seriously damaging the vending machine's primary structure.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Therefore, the invention as described herein contemplates all such embodiments as may come within the scope of the following claims and equivalents thereof.

We claim:

1. A locking system wherein a door is locked and unlocked to a cabinet, the locking system comprising in combination:
a sliding mechanical linkage having locked and unlocked positions;
a motor carried either by the door or by the cabinet; the motor rotatably connected to the linkage; and
a controller for driving the motor to slide the linkage from the locked to the unlocked position.

2. A locking system as in claim 1 wherein the motor is driven to slide the linkage from the unlocked to the locked position.

3. A locking system as in claim 1 wherein the motor is a two-direction reversible motor.

4. A locking system as in claim 1 wherein the locked position of the linkage is force resisting.

5. A locking system as in claim 1 wherein the motor drives the linkage through a gear reducer.

6. A locking system as in claim 5 wherein the gear reducer comprises first reduction gears and a second gear reducer.

7. A locking system as in claim 6 wherein the second gear reducer comprises a worm gear and a helical gear.

8. A locking system as in claim 7 wherein the helical gear connects to at least two teeth of the worm gear.

9. A locking system as in claim 1 further comprising:
an access controller.

10. A locking system as in claim 9 wherein the access controller is remotely operable.

11. A locking system as in claim 9 further comprising:
an override for energizing the motor independently of the access controller.

12. A locking system as in claim 9 wherein the access controller and the motor are powered by a battery source.

13. A locking system as in claim 9 wherein a position switch provides a lock trigger signal for energizing the motor to lock the linkage.

14. A locking system as in claim 9 wherein the access controller is operated by an access input device carried by the door or by the cabinet.

15. A locking system as in claim 9 further comprising:
a sensor to detect motor current and to either reverse the motor direction or de-energize the motor upon reaching predetermined current levels.

16. A locking system as in claim 9 wherein the access controller is operable only by input of a unique preset access code signal.

17. A method of unlocking a door to a cabinet wherein a mechanical slide is carried by either the door or by the cabinet, and wherein a mechanical linkage moves the slide for unlocking the door, the method comprising:
providing a motor with an electronic motor controller to drive the mechanical linkage between a force-resisting locked position and an open position; and
powering the motor to drive the linkage thereby unlocking the slide.

18. A method as in claim 17 further comprising:
providing a microcomputer for directing operation of the electronic motor controller and of the motor.

19. A method as in claim 18 further comprising:
providing an access controller.

20. A locking system for vending machines wherein a door is locked and unlocked to a cabinet on which the door is pivotally mounted, the locking system comprising in combination:
a slide carried either by the door or by the cabinet;
a mechanical linkage for moving the slide for unlocking the door from the cabinet;
a motor for driving the mechanical linkage from a force-resisting locked position to an open position; and
a motor controller for operating the motor to drive the mechanical linkage to unlock the slide between the door and the cabinet.

21. A locking system as in claim 20 wherein the motor is rotatably connected for driving the mechanical linkage from the open position to the force-resisting locked position, and wherein the motor controller operates the motor to drive the mechanical linkage to lock the slide between the door and the cabinet.

22. A locking system for safes wherein a door is locked and unlocked to a cabinet on which the door is pivotally mounted, the locking system comprising in combination:
a slide carried either by the door or by the cabinet;
a mechanical linkage for moving the slide for locking and unlocking the door with the cabinet;
a motor rotatably connected for driving the mechanical linkage to a force-resisting locked position and an open position; and
an electronic motor controller for operating the motor to drive the mechanical linkage to lock and unlock the slide between the door and the cabinet.

23. A locking system as in claim 22 wherein the motor is reversible and operable in two directions to move the slide.

24. A locking system as in claim 22 wherein the motor is reversible and operable in one direction to move the slide.

25. A locking system as in claim 22 wherein the electronic motor controller comprises a microcomputer for directing operation of the motor.

26. A locking system as in claim 22 wherein the slide comprises a push-pull cable.

27. A locking system as in claim 22 wherein the slide comprises a push-pull rod.

28. A locking system as in claim 22 wherein the mechanical linkage and slide are gear driven.

29. A method of unlocking a door to a cabinet comprising:
providing a rotational force generator carried by either the door or the cabinet;
connecting a mechanical force converter to the rotational force generator for converting rotational force to a linear drive force;
attaching the mechanical force converter to a latch mechanism operable to slide between a locked and an unlocked position; and
controllably driving the latch mechanism from the locked to the unlocked position.

30. A method of unlocking a door as in claim 29 wherein the rotational force generator is a motor that includes an access controller.

31. A method of unlocking a door as in claim 30 wherein the access controller is remotely operable.

32. A method of unlocking a door as in claim 30 wherein the access controller and the motor are powered by a battery source.

33. A method of locking a door to a cabinet comprising:
providing a rotational force generator carried by either the door or the cabinet;
connecting a mechanical force converter to the rotational force generator for converting the rotational force to a linear drive force;
attaching the mechanical force converter to a latch mechanism operable to slide between an unlocked and a locked position; and
controllably driving the latch mechanism from the unlocked to the locked position.

34. A method of locking a door as in claim 33 wherein the rotational force generator is a motor that includes an access controller.

35. A method of locking a door as in claim 34 wherein the access controller is remotely operable.

36. A method of locking a door as in claim 34 wherein the access controller and the motor are powered by a battery source.
